(19) United States
(12) Patent Application Publication
(10) Pub. No.: US 2022/0036620 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/007,989

(22) Filed: Aug. 31, 2020

(30) Foreign Application Priority Data
Jul. 29, 2020 (JP) 2020-128296

(51) Int. Cl. G06T 13/40

(52) U.S. Cl. CPC G06T 13/40

(57) ABSTRACT

To reduce the burden of animation production, an animation production system comprises a virtual camera that shoots a character placed in a virtual space; and a parameter list that displays a list of parameter sets available for the shooting in the virtual space, wherein the shooting is performed by applying the parameter set selected from the parameter list to the virtual space.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

In creating an animation, a scene structure (e.g., the arrangement of a character or object relative to a camera) is important. However, it is not always easy for the creator to think of a scene structure within the virtual space and arrange a character or the like in accordance with the image, and it may take a lot of time here.

The present invention has been made in view of this background, and is intended to provide a technology that can reduce the burden of animation production.

### Solution to Problem

The principal invention for solving the above-described problem is an animation production system comprising: a virtual camera that shoots a character placed in a virtual space; and a parameter list that displays a list of parameter sets available for the shooting in the virtual space, wherein the shooting is performed by applying the parameter set selected from the parameter list to the virtual space.

The other problems disclosed in the present application and the method for solving them are clarified in the sections and drawings of the embodiments of the invention.

### Advantageous Effects of Invention

According to the present invention, the burden of animation production can be reduced.

### BRIEF DESCRIPTION OF DRAWINGS

FIG. 1 is a diagram illustrating an example of a virtual space displayed on an HMD mounted by a user in an animation production system of the present embodiment;

FIG. 2 is a diagram illustrating an example of the overall configuration of an animation production system 300 according to an embodiment of the present invention.

FIG. 3 is a schematic view illustrating an appearance of an HMD 110 according to the present embodiment;

FIG. 4 is a diagram illustrating an example of a functional configuration of the HMD 110 according to the present embodiment;

FIG. 5 shows a schematic view of the appearance of the controller 210 according to the present embodiment.

FIG. 6 is a diagram illustrating an example of a functional configuration of a controller 210 according to the present embodiment;

FIG. 7 is a diagram illustrating an example of a functional configuration of an image producing device 310 according to the present embodiment;

FIG. 8 is a diagram illustrating the purchase of a parameter set from the parameter list 6 in the animation production system 300 according to the present embodiment;

FIG. 9 is a diagram illustrating the purchase of a parameter set from the parameter list 6 in the animation production system 300 according to the present embodiment;

FIG. 10 is a diagram illustrating the purchase, etc. of a parameter set from a parameter list 6 in the animation production system 300 according to the present embodiment.

FIG. 11 is a diagram illustrating a set of retained parameters from a parameter list 6 of the animation production system 300 according to the present embodiment;

FIG. 12 is a diagram illustrating a set of retained parameters from a parameter list 6 of the animation production system 300 according to the present embodiment;

FIG. 13 is a diagram illustrating a set of retained parameters from a parameter list 6 of the animation production system 300 according to the present embodiment;

FIG. 14 is a diagram illustrating a set of retained parameters from a parameter list 6 of the animation production system 300 according to the present embodiment;

### DESCRIPTION OF EMBODIMENTS

The contents of embodiments of the present invention will be described with reference. The present invention includes, for example, the following configurations.

### [Item 1]

An animation production system comprising:
a virtual camera that shoots a character placed in a virtual space; and
a parameter list that displays a list of parameter sets available for the shooting in the virtual space,
wherein the shooting is performed by applying the parameter set selected from the parameter list to the virtual space.

### [Item 2]

The animation production system according to claim 1, wherein
the selected parameter set relates to the placement of the camera and the 3DCG model of a character or an object.

### [Item 3]

The animation production system according to claim 1, wherein
the selected parameter set relates to an arrangement of the camera and the background model.

### [Item 4]

The animation production system according to claim 1, wherein
the selected parameter set relates to an effect of the camera image.

### [Item 5]

The animation production system according to claim 1, wherein
when the parameter set is selected, the image or video to which the parameter set is applied is displayed.

### [Item 6]

The animation production system according to claim 1, wherein
the parameter set in the parameter list is provided by a server connected via a network.

### [Item 7]

The animation production system according to claim 1, wherein
the parameter set in the parameter list is registered by a user.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### <Overview>

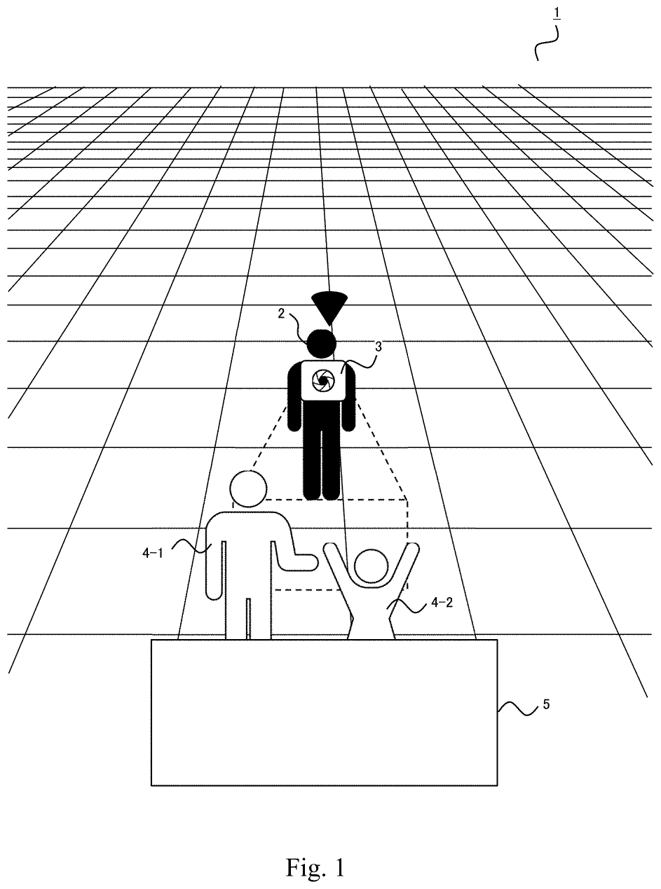

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3, a background model 5, and an object (e.g., a chair, a desk, etc., not shown) are arranged in the virtual space 1, and a character 4, a background model 5, and an object are shot using the camera 3. In the virtual space 1, a photographer 2 (a photographer character) is disposed, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 3 can be virtually operated as the photographer 2, natural camera work can be realized and the representation of the movie to be shot can be enriched.

### <General Configuration>

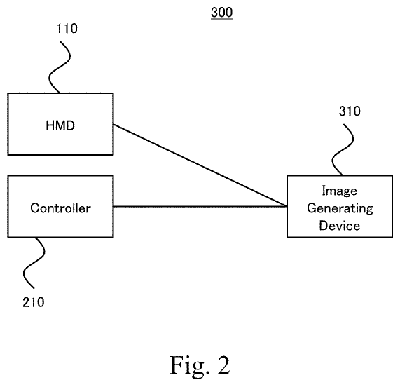

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### <HMD 110>

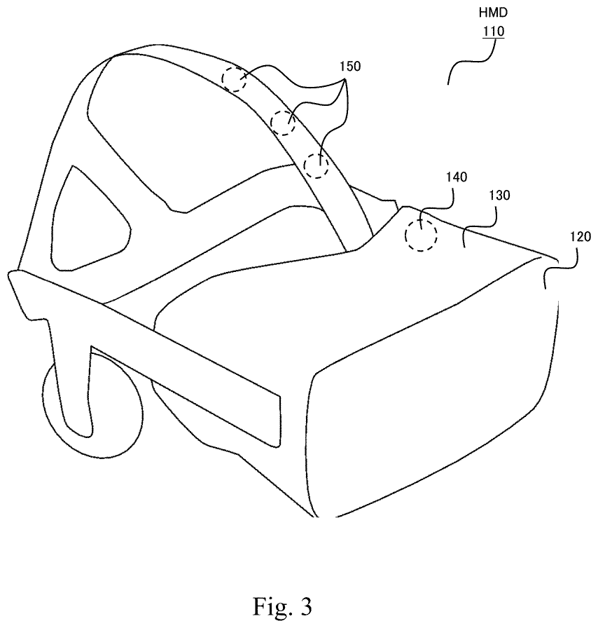

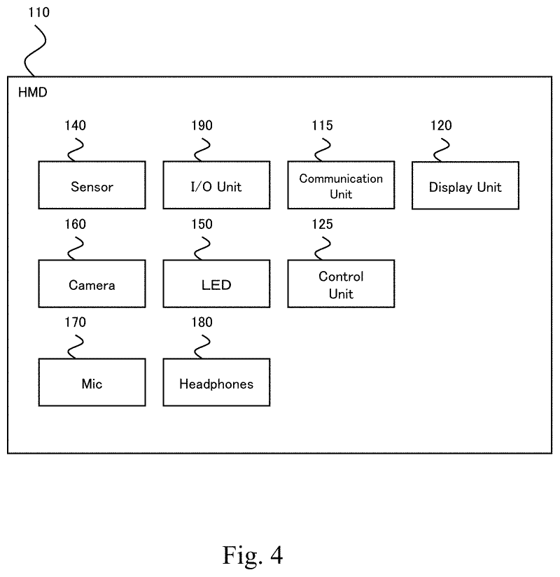

FIG. 3 shows a schematic view of the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although an optically transmissive and non-transmissive display is contemplated as the display panel, this embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

<controller 210>

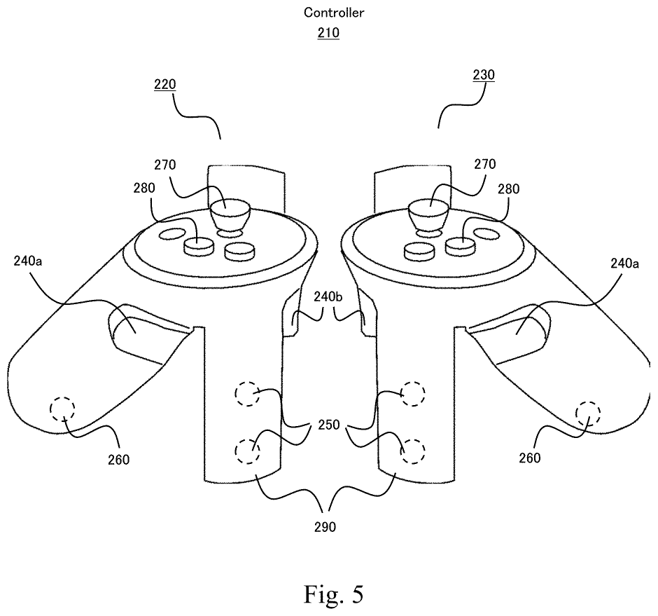

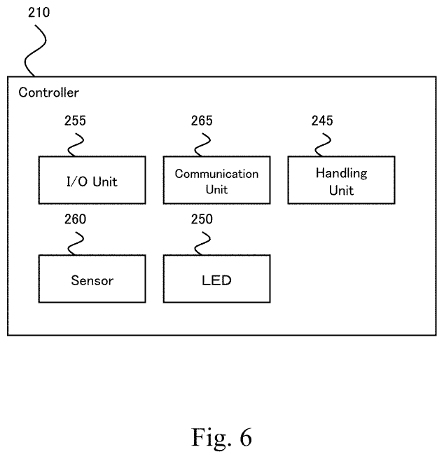

FIG. 5 shows a schematic view of the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### <Image Generator 310>

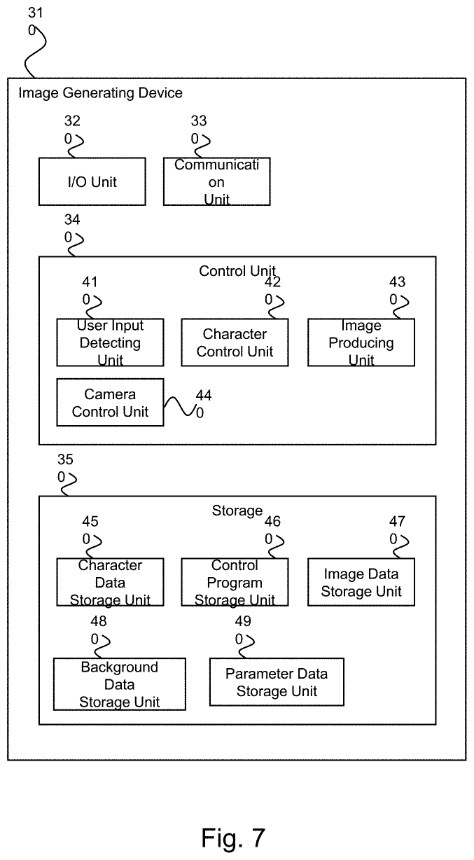

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head, the user's speech, and the movement and operation of the controller, a character control unit 420 that executes a control program stored in the control program storage unit 460 for a character 4 stored in the character data storage unit 450 of the storage unit 350, a camera control unit 440 that controls a virtual camera 3 disposed in the virtual space 1 according to the character control, and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4.

The storage unit 350 stores in the aforementioned character data storage unit 450 information related to the character 4, such as the attribute of the character 4, as well as the image data of the character 4. The control program storage unit 460 controls the operation and expression of the character 4 in the virtual space and stores a program for controlling an object such as the camera 3. The image data storage unit 470 stores the image generated by the image producing unit 430. The background data storage unit 480 stores information related to the background model 5. The parameter data storage unit 490 stores the parameter set purchased on the parameter list or the parameter set registered by the user.

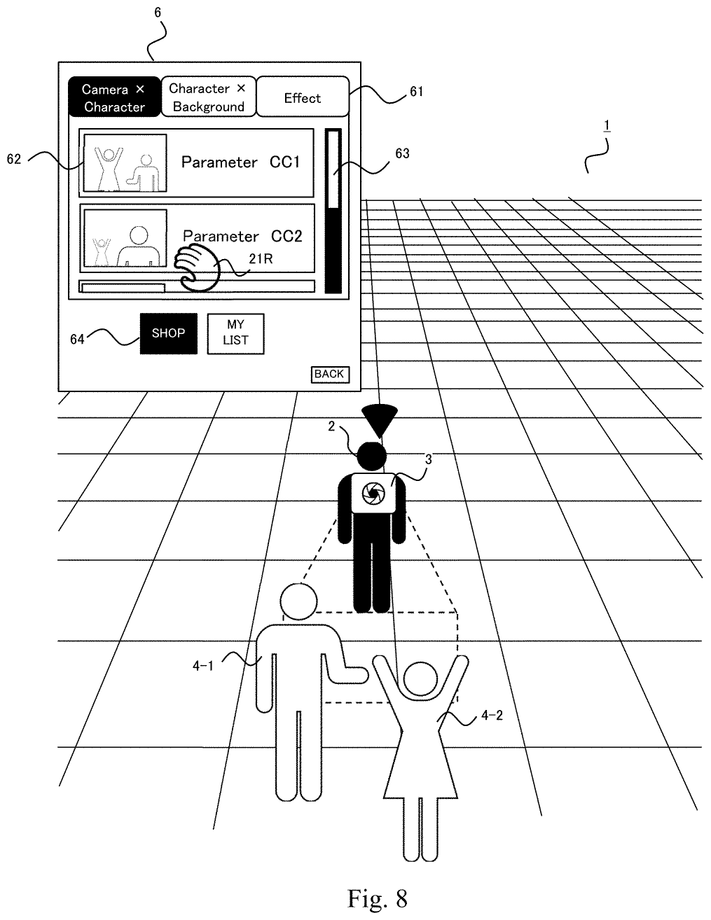

FIG. 8-14 is a diagram illustrating the purchase of a parameter set from the parameter list 6 in the animation production system 300 according to the present embodiment. The parameter types, etc. included in the parameter list of the present embodiment are not limited to those shown in FIG. 8, etc., but may be configured to include one or more of the following parameters or may include other parameter types.

First, as shown in FIG. 8, the user opens the parameter list 6 on the virtual space 1 and selects a parameter set (e.g., Parameter CC2) for placement of the camera 3 and the character 4, e.g., in a parameter shop preset. The parameter list 6 includes a parameter type tab 61, a parameter item 62, a scroll bar 63, and a button 64.

The parameter type tab 61 may be, for example, a placement parameter (Camera×Character) between the camera 3 and the character 4, a placement parameter (Character×Background) between the character 4 and the background model 5, and an effect setting parameter (Effect), as illustrated in FIG. 8. Effects may include, for example, Bloom effects, Depth of Field effects, Bigneting effects, Color Grading effects, Color Curve effects, diffusion filters, and the like, and the like. The effect setting parameters may then include, for example, parameters such as size or color. The parameter type is not limited thereto, and any parameter may be possessed, such as a placement parameter between the camera 3 and the object, a placement parameter between the character 4 and the object, a setting of the camera 3 itself (e.g., a magnification of the zoom, etc.), and the like.

Parameter item 62 is changed according to the selection of parameter type tab 61 and a list corresponding to each type is displayed. The items displayed in this list may be data obtained from a server connected via a network such as a cloud server, for example. In FIG. 8, a list of the placement parameters of the camera 3 and the character 4 is illustrated, and a composition sample image and a name are represented in each item as an example. However, the list may not be limited thereto, for example, an amount, a composition setting, or the like may be displayed. In addition, if there are many display items, for example, a scroll bar 63 may be slid to allow all items to be checked, or a sort may be possible, such as in the order of fifty sounds or in the order of money. Each item may be sold not only as a single set of parameters, but also as a set of parameters of the same or different parameter types.

Buttons 64 can be arranged for a variety of applications, and in FIG. 8, an example of a parameter set purchase button (SHOP), a set of possessed parameters (MY LIST), or a button that returns to the previous window display (BACK) is shown.

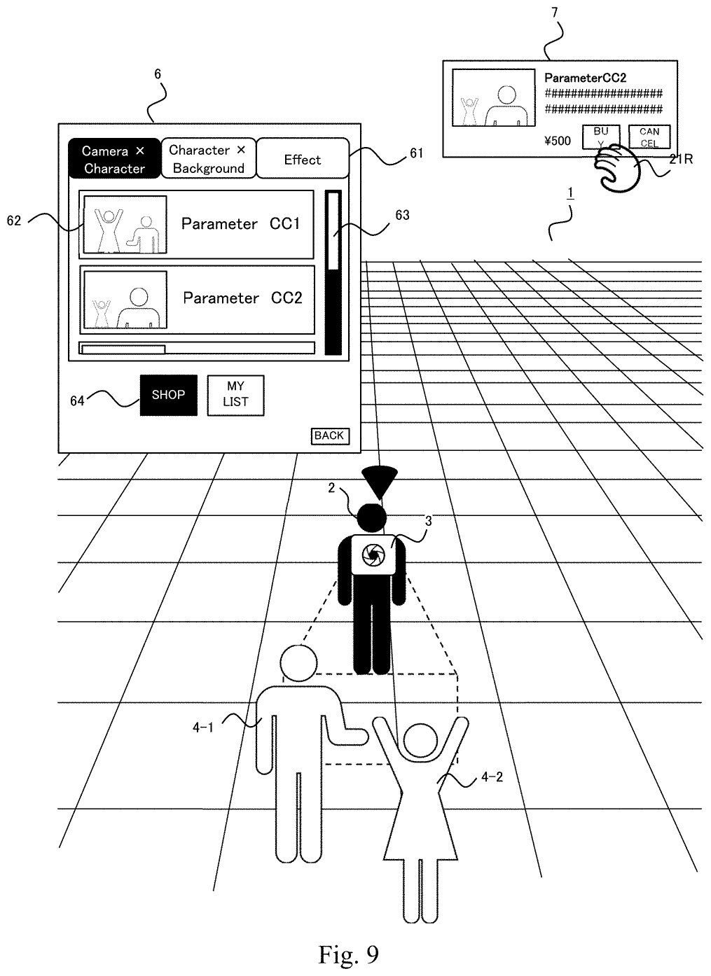

Next, as shown in FIG. 9, the user may select one of the parameter items 62 by the virtual right-hand 21R in the virtual space 1 to display, for example, the item data 7 (e.g., a detailed explanation of the items, the amount at the time of purchase, etc.).

For example, after confirming the content of the item data 7, the purchase procedure may be performed by pressing the purchase decision button (BUY) on the item data 7 or the button to which the decision operation of the controller 210 has been assigned.

As described above, the purchase of a parameter set has been described in accordance with FIGS. 8 and 9, but rental may also have substantially the same configuration except that the use period after payment is limited.

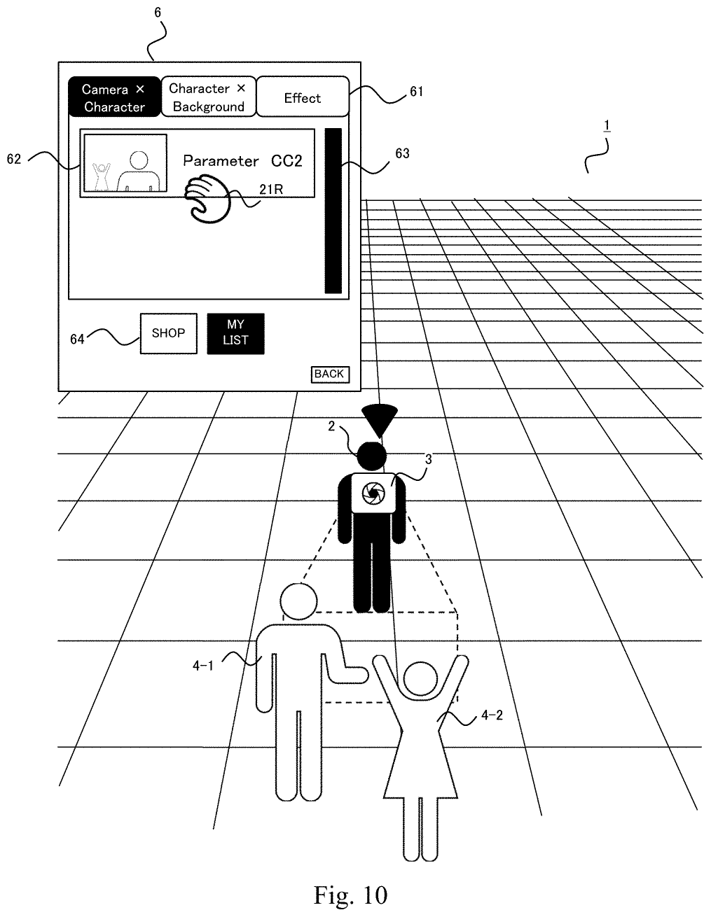

Next, parameters for the camera work may be provided in parameter list 6. As shown in FIG. 10, the user may open the parameter list 6 on the virtual space 1 and select, for example, a parameter set (e.g., Parameter CC2) for the placement of the camera 3 and the character 4 in the Holding Parameter Set List. The parameter set may be set to a fixed position of the camera 3 or may be set to a change in position (including leads and tracks, which may or may not be horizontally moved) on the assumption that the camera 3 moves. In addition, the function of camera 3 such as pan, tilt, roll, and zoom can be set in the parameter set.

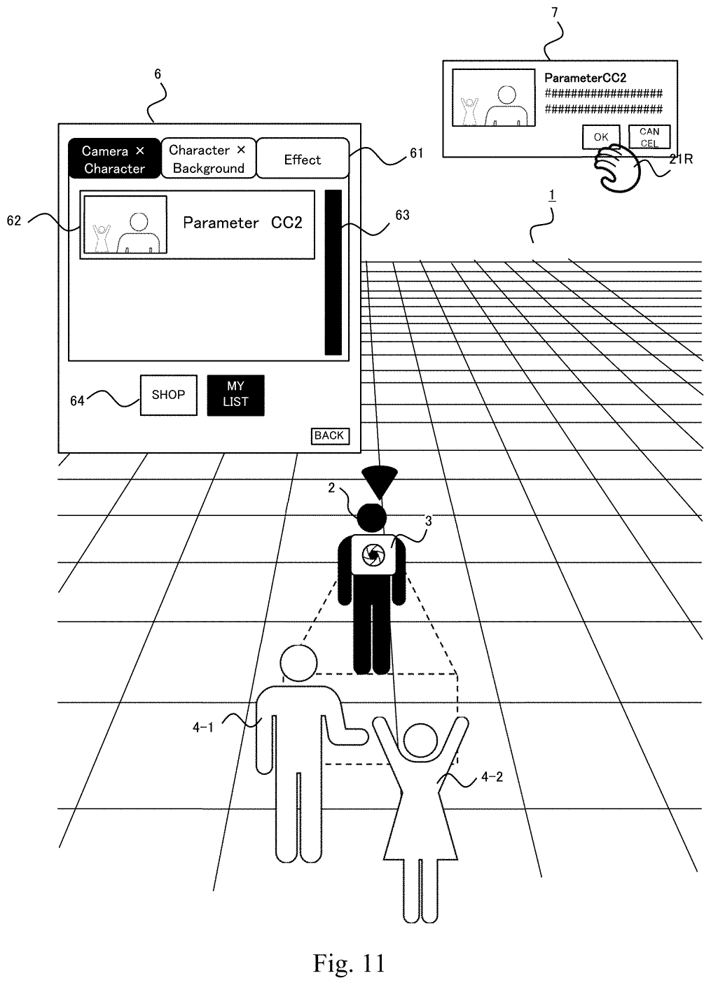

Next, as shown in FIG. 11, a user may select one of the parameter items 62 by virtual right-hand 21R in virtual space 1 to display, for example, item data 7 (e.g., a detailed description of the items, etc.).

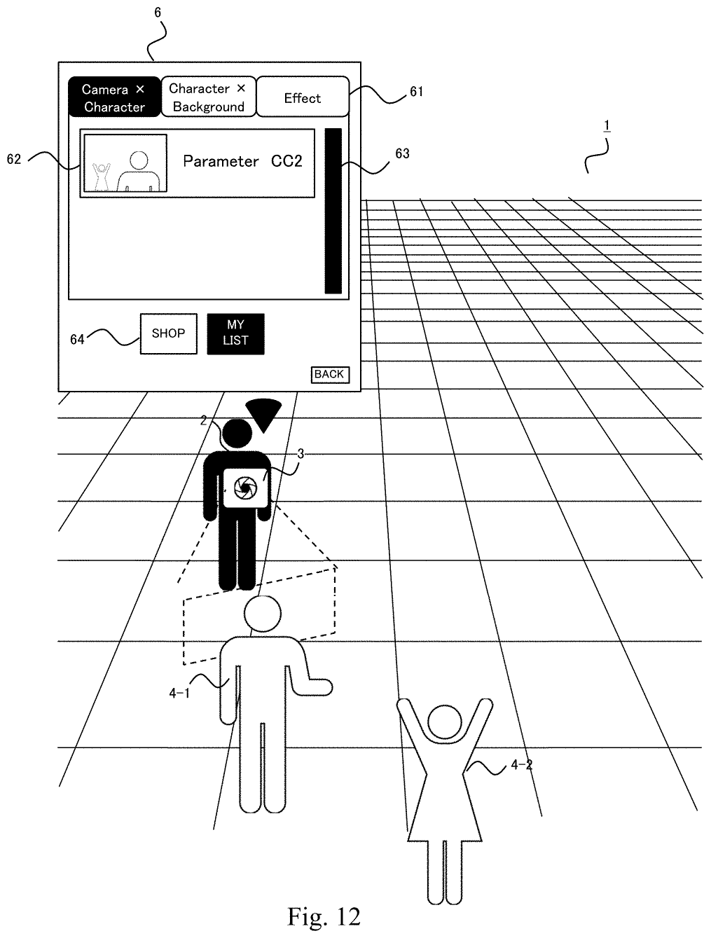

For example, after confirming the content of the item data 7, the selected parameter set may be applied to the virtual space 1 by pressing a decision button (OK) on the item data 7 or a button to which the decision operation of the controller 210 has been assigned. FIG. 12 illustrates the post-application arrangement. It is also possible to register a set of parameters created by the author in the list of possession parameters.

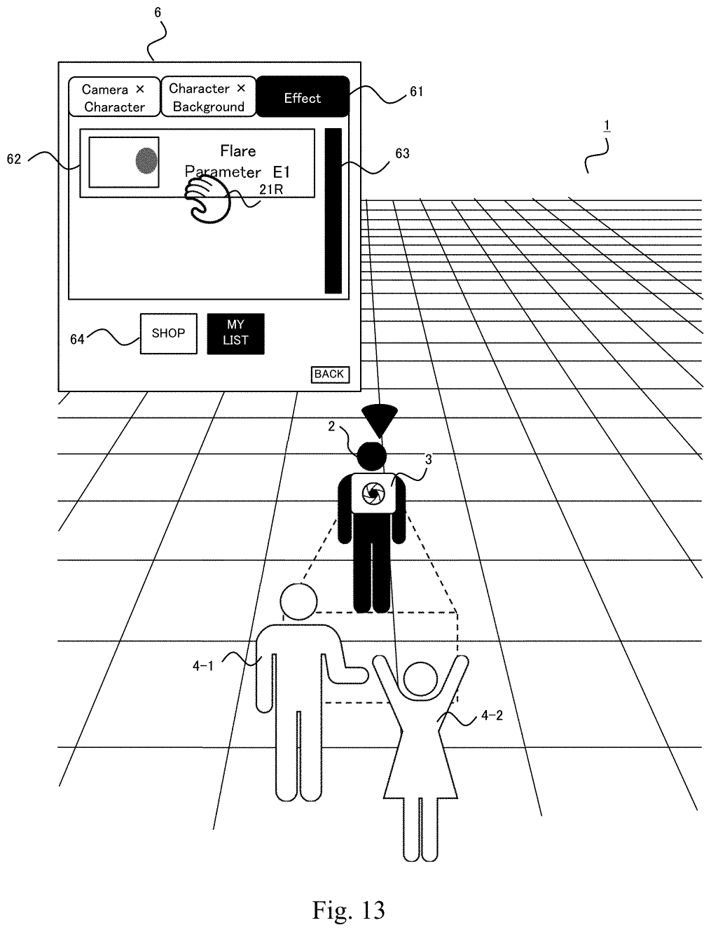

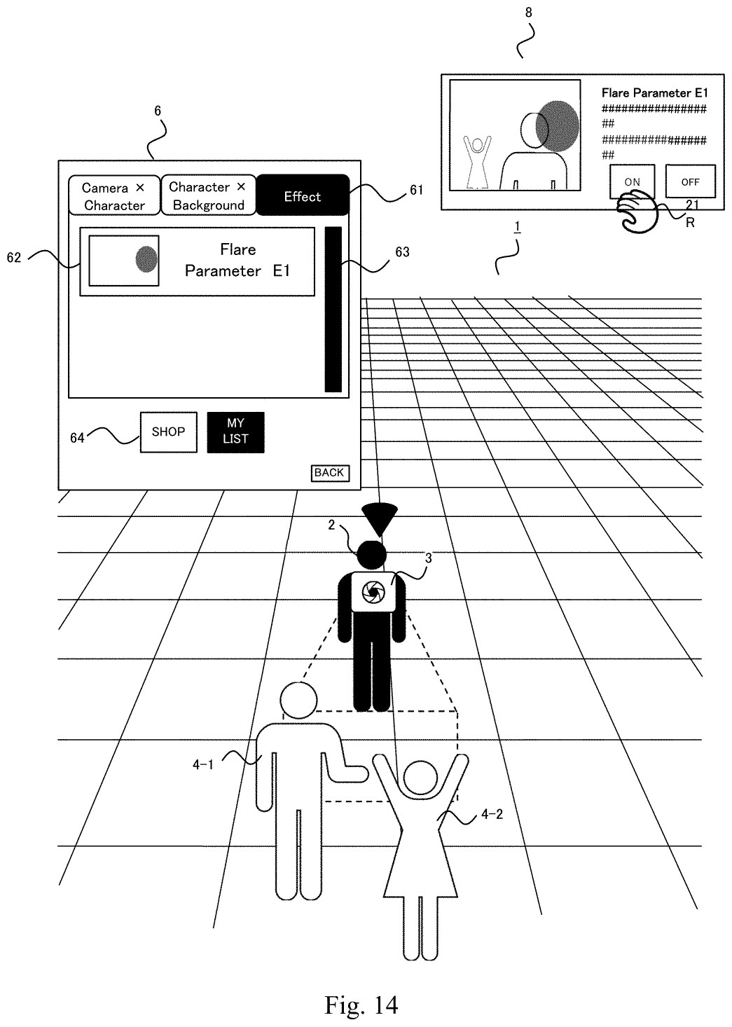

FIG. 13 illustrates an example of a set of effects holding parameters, such as flare size and color, as an example. Then, for example, as shown in FIG. 14, when the user selects one of the parameter items 62 by the virtual right-hand 21R in the virtual space 1, the sample window 8 may open in the virtual space 1 and image from the camera 3 to which the selected effect has been applied may be displayed. The sample window 8 may also be displayed when purchasing the effect setting parameters or the like, so that the image or image after the effect is applied can be checked before the purchase or the like.

In this embodiment, the effect is applied to the rendered moving image, but the effect that can be disposed in the virtual space 1 may be presented to the parameter list. For example, a fog material, flare material, rain material, or the like may be presented to parameter list 6 with a set of objects and effects defining their appearance or behavior. In this case, instead of the flare parameter set shown in FIG. 13, a parameter set (including an object) for the flare asset can be presented in the parameter list. When the user selects one of the parameter items 62 by the virtual right-hand 21R in the virtual space 1 as shown in FIG. 14, for example, an object pertaining to the flare material may be disposed in the virtual space 1 so that the flare effect is provided in the virtual space 1 by the object.

Parameter sets can also be set for lighting parameters. In other words, a parameter set can be included as a parameter, such as where a light source (light) is located, setting of a light color tone, setting of a brightness, a change in brightness (a representation such as a flash lights), setting of a light direction, and a change in a light direction.

According to the animation production system 300 of the present embodiment, since the producer can acquire various parameter sets without preparing by himself, it is possible to reduce the time for examining the scene composition. In addition, it is possible to take pictures using a composition that was not expected by the producer alone, thereby expanding the range of animated video representations. Thus, it reduces the burden of animation production and provides a richer representation of animated video.

For parameters with time-series variations, such as camera 3, lighting, or character 4 operation, the parameter set can contain time information. The time information can be a relative time from the start time (t=+10 seconds, etc.). For specifying the change of parameters over time, it is possible to change them by a function that is linear or dependent on a predetermined time, including the first set value at the start of the change and the second set value at the end of the change. The user may also use multiple set of parameters concatenated. In addition, for a parameter set including a time-dependent element, the starting and ending points of the change may be individually changed, or the parameter may be automatically corrected so that the time required for the change is changed at a specified time.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space

2 cameraman

3 cameras

4 characters

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 character data storage section

460 Program Storage

470 Image Data Storage

1. An animation production system comprising:
a virtual camera that shoots a character placed in a virtual space; and
a parameter list that displays a list of parameter sets available for the shooting in the virtual space,
wherein
a parameter set in the list of the parameter sets is selected, and the shooting is performed by applying the parameter set selected from the parameter list to the virtual space, and
the selected parameter set relates to relative placements of the virtual camera and another object, the another object including a character model or a background model.

2.-3. (canceled)

4. The animation production system according to claim 1, wherein
the selected parameter set relates to an effect of image from the camera.

5. The animation production system according to claim 1, wherein
when the parameter set is selected, image or video to which the parameter set is applied is displayed.

6. The animation production system according to claim 1, wherein
the parameter set in the parameter list is provided by a server connected via a network.

7. The animation production system according to claim 1, wherein
the parameter set in the parameter list is registered by a user.
